(19) United States
(12) Patent Application Publication
(10) Pub. No.: US 2006/0028157 A1
(43) Pub. Date: Feb. 9, 2006

(54) Wireless pneumatic safe device

(76) Inventor: Chen Wei Ying, Taichung City (TW)

Correspondence Address: Chen Wei Ying, P.O. Box 63-150, Taichung City, 406, TW

(21) Appl. No.: 10/909,855

(22) Filed: Aug. 3, 2004

(51) Int. Cl. H02P 1/54

(52) U.S. Cl. 318/56

(57) ABSTRACT

A wireless pneumatic safe device includes an actuated tube mounted on a lower edge of an electric rolling door. The actuated tube has a closed chamber longitudinally defined therein. A hose communicates with the chamber. A control unit is mounted on the electric rolling door. The hose is further connected to the control unit for transmitting a compressed air from the actuated tube to the control unit. The control unit transmits a disconnection signal or a reversal signal when receiving the compressed air from the actuated tube. A radio receiver is mounted to and electrically connected to a motor. The radio receiver transmits a disconnection order or a reversal order to the motor for stopping or reversely operating the electric rolling door for achieving a purpose of safety when receiving the disconnection signal/the reversal signal from the control unit.

### BACKGROUND OF THE INVENTION

1. Field of the Invention

The present invention relates to safe device, and more particularly to a wireless pneumatic safe device that can immediately stop or reversely operate a moving structure.

2. Description of Related Art

An electric rolling door usually includes a safe device mounted thereon for promoting the safe coefficient thereof. The safe device can stop the operated electric rolling door when pressing an object for preventing the operator from being hurt and preventing the object from being broken.

The conventional safe device in accordance with the prior art comprises a pressure sensor mounted on the upper portion of the electric rolling door and a receiver mounted on a motor of the electric rolling door. The receiver is electrically connected to the pressure sensor by wires. The moving speed of the electric rolling door is reduced when contact with an object. At the same time, a reacting force acts on the electric rolling door. The pressure sensor will transmits a signal to the receiver via the wires when the value of the reacting force is greater than the establishment value of the pressure sensor. The receiver transmits a disconnection order to the motor for stopping the electric rolling door.

However, the conventional safe device includes multiple disadvantages as follow.

1. The electric rolling door is stopped when the value of the reacting force is greater than the establishment value of the pressure sensor. As a result, the electric rolling door is not immediately stopped when contacting with the object. Consequently, the object may be broken when being fragile and the slowing down electric rolling door may hurt a child.

2. The pressure sensor and the receiver are connected by wires such that the conventional safe device may be out of order and provide no safety to the electric rolling door when the wires are broken due to an improper force.

The present invention has arisen to mitigate and/or obviate the disadvantages of the conventional safe device.

### SUMMARY OF THE INVENTION

The main objective of the present invention is to provide an improved safe device that can immediately stop or reversely operate a moving structure, such as an electric rolling door.

To achieve the objective, the wireless pneumatic safe device in accordance with the present invention comprises an actuated tube mounted on a lower edge of an electric rolling door. The actuated tube is made of flexible material and has a closed chamber longitudinally defined therein. A hose has a first end secured on the actuated tube and communicating with the chamber. A control unit is mounted on the electric rolling door. The hose has a second end connected to the control unit for transmitting a compressed air from the actuated tube to the control unit. The control unit transmits a disconnection signal or a reversal signal when receiving the compressed air from the actuated tube. A radio receiver is mounted to and electrically connected to a motor. The radio receiver transmits a disconnection order or a reversal order to the motor for stopping or reversely operating the electric rolling door for achieving a purpose of safety when receiving the disconnection signal or the reversal signal from the control unit.

Further benefits and advantages of the present invention will become apparent after a careful reading of the detailed description with appropriate reference to the accompanying drawings.

### BRIEF DESCRIPTION OF THE DRAWINGS

FIG. 1 is an exploded perspective view of a wireless pneumatic safe device in accordance with the present invention;

FIG. 2 is a perspective view of the wireless pneumatic safe device in accordance with the present invention;

FIG. 3 is a cross-sectional view of the wireless pneumatic safe device in FIG. 2;

FIG. 4 is a cross-sectional view of an actuated tube of the safe device in accordance with the present invention;

FIG. 5 is an operational view in cross section of the safe device of the present invention;

FIG. 6 is an operational view in cross section of the safe device of the present invention when the actuated tube is pressed; and

FIG. 7 is a flow chart of the wireless pneumatic safe device in accordance with the present invention.

### DETAILED DESCRIPTION OF THE INVENTION

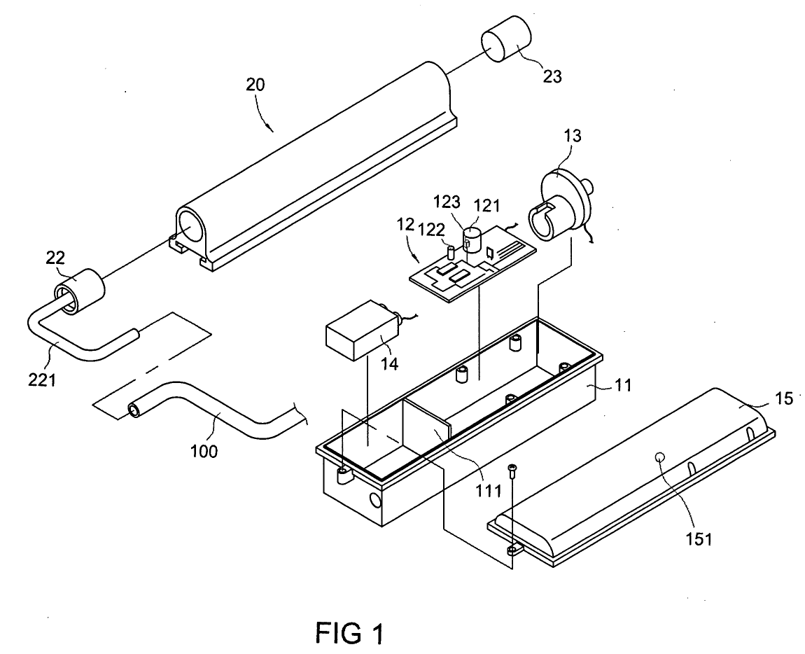

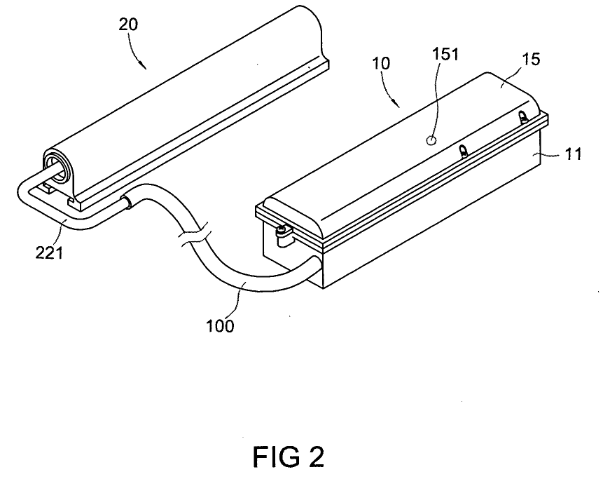

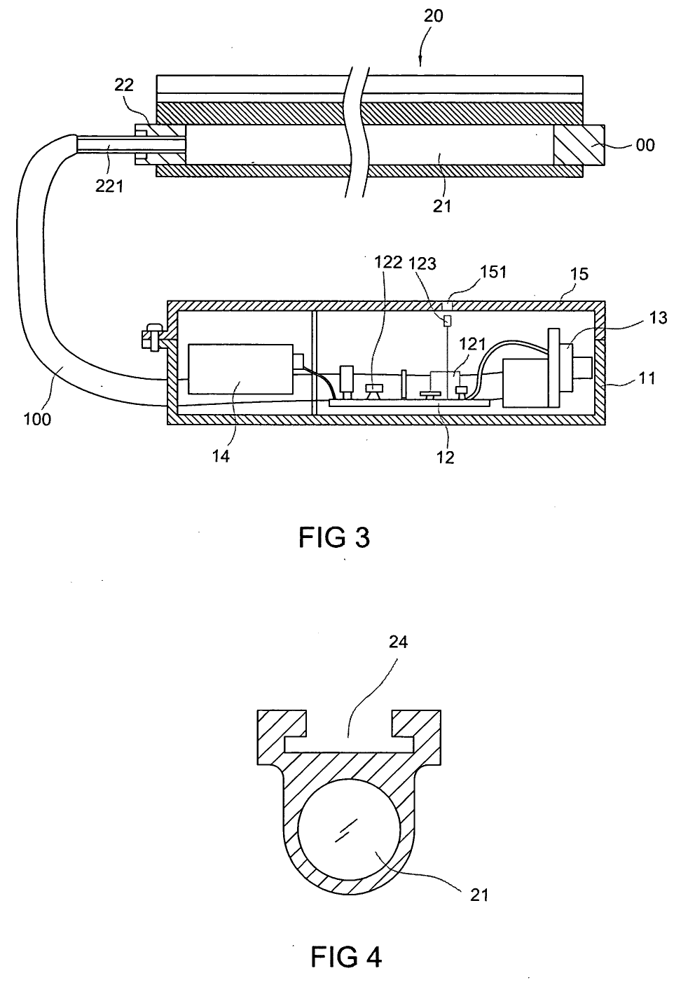

Referring to the drawings and initially to FIGS. 1-5, a wireless pneumatic safe device in accordance with the present invention comprises a control unit (10), an actuated tube (20) mounted on a lower side of an electric rolling door (40) and a radio receiver (30) adapted to be electrically mounted on a motor (41) of the electric rolling door (40). The control unit (10) is connected to the actuated tube (20) via a hose (100).

The control unit (10) includes a housing (11) having a partition (111) upwardly extending from a bottom of the housing (10) to divide the housing (11) into a first portion and a second portion. A circuit board (12) and a pneumatic sensor (13) are respectively mounted in the first portion in the housing (11) and electrically connected to each other. The hose (100) has a first end received in the pneumatic sensor (13) and a second end communicating with an inner periphery of the actuated tube (20). A battery (14) is received in the second portion of the housing (11) and electrically connected to the circuit board (12) for providing power to the circuit board (12) and the pneumatic sensor (13). A buzzer (121), a radio transmitter (122) and a light emitting diode (123) are respectively electrically mounted on the circuit board (12). A cover (15) is detachably mounted on the housing (11) for closing the housing (11). A window (151) is formed in the cover (15) and aligns with the light emitting diode (123) such that the user can see the alarm from the light emitting diode (123).

The actuated tube (20) is made of flexible material and includes a chamber (21) longitudinally defined therein. A first end piece (22) and a second end piece (23) are respectively airtightly inserted into two opposite ends of the actuated tube (20) for closing the chamber (21). A hollow insertion (221) is inserted into the first end piece (22) and communicates with the chamber (21). The second end of the hose (100) is sleeved on a free end of the insertion (221) such that the hose (100) communicates with the chamber (21) in the actuated tube (20). A buckling groove (24) is longitudinally defined in an outer periphery of the actuated tube (20). The buckling groove (24) is adapted to receive a lower edge of the electric rolling door (41) to hold the actuated tube (20) in place.

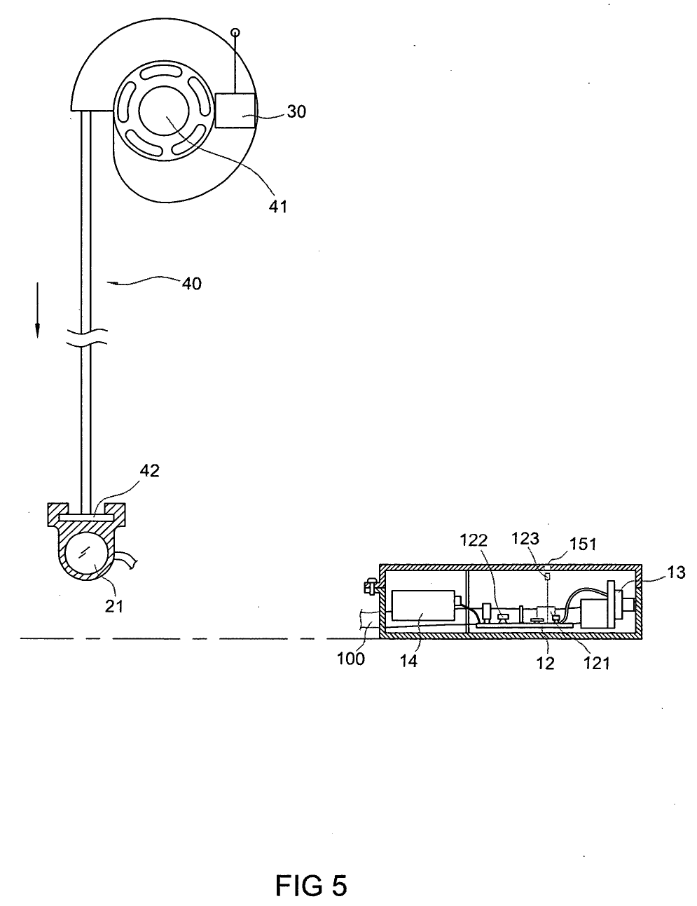

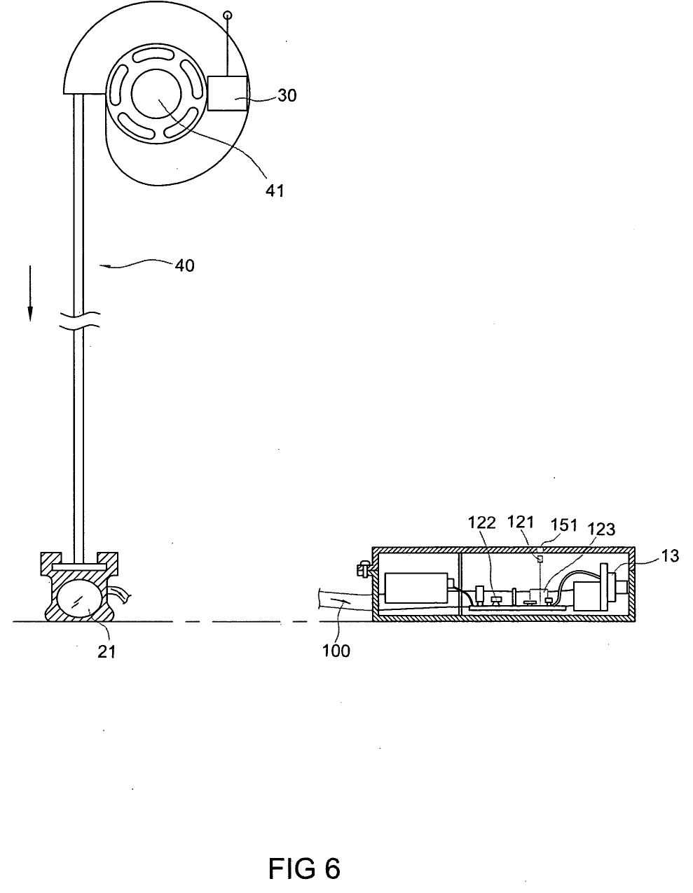

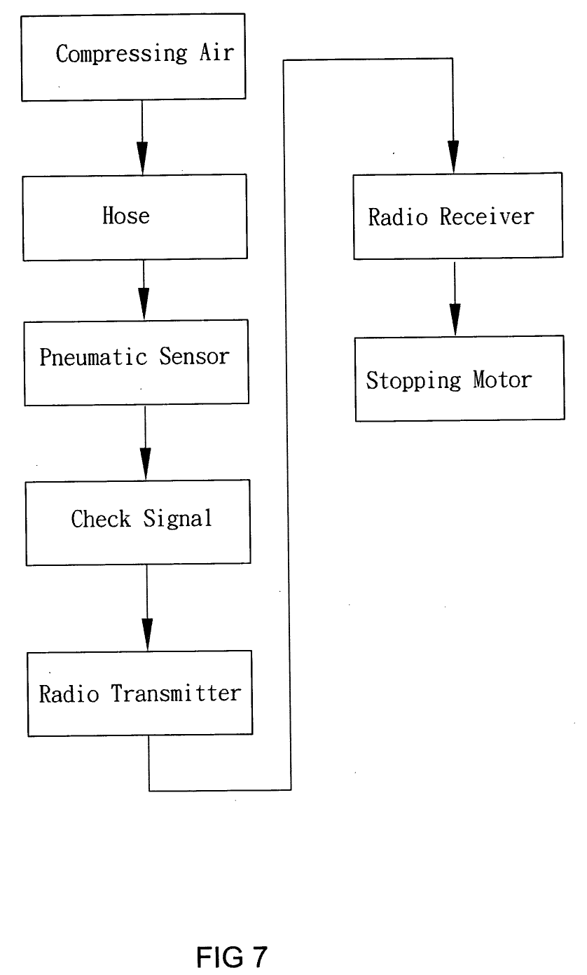

With reference to FIGS. 5-7, when operating the electric rolling door (40), the actuated tube (20) is transfigured to compress the air in the chamber (21) due to the material property thereof when the actuated tube (20) contacting with an object. The compressed air flows to the pneumatic sensor (13) via the hollow insertion (221) and the hose (100). The pneumatic sensor (13) transmits a check signal to the circuit board (12) when sensing the compressed air. The radio transmitter (122) wirelessly transmits a disconnection signal or a reversal signal when the circuit board (12) receiving the check signal. The radio receiver (30) transmits a disconnection order or a reversal order to the motor (41) of the electric rolling door (40) for stopping or reversely operating the electric rolling door (40) for achieving a purpose of safety when receiving the disconnection signal or the reversal signal from the radio transmitter (122). At the same time, the buzzer (121) sounds and the light emitting diode (123) lights to transmit a warn to the operator who operates the electric rolling door (40) and wants to leave for finishing operation. In addition, the buzzer (121) continually sounds when the battery (14) is in a condition of low-voltage for reminding the operator to replace the battery (14).

As described above, the wireless pneumatic safe device in accordance with the present invention includes the advantages as follow.

1. The actuated tube (20) of the present invention is made of flexible material such that the actuated tube (20) is easily to be transfigured. Consequently, the present invention almost immediately stops or reversely operates the electric rolling door (40) when the actuated tube (20) contacts with the object, thereby the safety is promoted.

2. The disconnection signal of the present invention is wirelessly transmitted such that the safe device of the present invention can effectively overcome the problem of a broken circuit of the conventional safe device.

3. The control unit (10) can be mounted near the actuated tube (20) for shortening the length of the hose (100) and the hose (100) is unlikely made of flexible material. Consequently, the hose (100) of the present invention is hardly to be broken sue to an improper force.

Although the invention has been explained in relation to its preferred embodiment, it is to be understood that many other possible modifications and variations can be made without departing from the spirit and scope of the invention as hereinafter claimed.

What is claimed is:

1. A wireless pneumatic safe device comprising:
an actuated tube adapted to be mounted on a lower edge of an electric rolling door, the actuated tube made of flexible material and having a closed chamber longitudinally defined therein;
a hose having a first end secured on the actuated tube and communicating with the chamber in the actuated tube;
a control unit adapted to be mounted on the electric rolling door near the actuated tube, the control unit having a housing, a pneumatic sensor, a circuit board and a battery respectively received in the housing and electrically connected to one another, the hose having a second end connected to the pneumatic sensor for transmitting a compressed air from the actuated tube to the pneumatic sensor, a radio transmitter electrically mounted on the circuit board for wirelessly transmitting a disconnection signal/a reversal signal when the circuit board receiving check signal from the pneumatic sensor, a cover detachably mounted to the housing for closing the housing; and
a radio receiver adapted to be mounted to and electrically connected to a motor of the electric rolling door, the radio receiver adapted to transmit a disconnection order/a reversal order to the motor of the electric rolling door for stopping/reversely operating the electric rolling door for achieving a purpose of safety when receiving the disconnection signal/the reversal signal from the radio transmitter.

2. The safe device as claimed in claim 1, wherein the actuated tube comprises a buckling groove longitudinally defined in an outer periphery thereof, the bucking adapted to receive the lower edge of the electric rolling door for holding the actuated tube in place.

3. The safe device as claimed in claim 1, wherein the circuit board comprises a light emitting diode electrically mounted thereon and the cover has a window defined therein, the window aligning with the light emitting diode, the light emitting diode lighting for a warn when the radio transmitter transmitting the disconnection signal/the reversal signal.

4. The safe device as claimed in claim 1, wherein the circuit board comprises a buzzer electrically mounted thereon and buzzing for a warn when the radio transmitter transmitting the disconnection signal/the reversal signal.

5. The safe device as claimed in claim 1 further comprising a first end piece and a second end piece respectively airtightly mounted to two opposite ends of the actuated tube for closing the chamber in the actuated tube, an hollow insertion longitudinally inserted into the first end piece and communicating with the chamber in the actuated tube, the first end of the hose sleeved on a free end of the hollow insertion.

6. The safe device as claimed in claim 2, wherein the circuit board comprises a light emitting diode electrically mounted thereon and the cover has a window defined therein, the window aligning with the light emitting diode, the light emitting diode lighting for a warn when the radio transmitter transmitting the disconnection signal/the reversal signal.

7. The safe device as claimed in claim 2, wherein the circuit board comprises a buzzer electrically mounted thereon and buzzing for a warn when the radio transmitter transmitting the disconnection signal/the reversal signal.

8. The safe device as claimed in claim 2 further comprising a first end piece and a second end piece respectively airtightly mounted to two opposite ends of the actuated tube for closing the chamber in the actuated tube, an hollow insertion longitudinally inserted into the first end piece and communicating with the chamber in the actuated tube, the first end of the hose sleeved on a free end of the hollow insertion.

9. The safe device as claimed in claim 3, wherein the circuit board comprises a buzzer electrically mounted thereon and buzzing for a warn when the radio transmitter transmitting the disconnection signal/the reversal signal.

10. The safe device as claimed in claim 3 further comprising a first end piece and a second end piece respectively airtightly mounted to two opposite ends of the actuated tube for closing the chamber in the actuated tube, an hollow insertion longitudinally inserted into the first end piece and communicating with the chamber in the actuated tube, the first end of the hose sleeved on a free end of the hollow insertion.

11. The safe device as claimed in claim 4 further comprising a first end piece and a second end piece respectively airtightly mounted to two opposite ends of the actuated tube for closing the chamber in the actuated tube, an hollow insertion longitudinally inserted into the first end piece and communicating with the chamber in the actuated tube, the first end of the hose sleeved on a free end of the hollow insertion.
